(19) United States
(12) Patent Application Publication
(10) Pub. No.: US 2016/0125076 A1
(43) Pub. Date: May 5, 2016

(54) MUSIC RECOMMENDATION SYSTEM FOR VEHICLE AND METHOD THEREOF

(71) Applicant: HYUNDAI MOTOR COMPANY, Seoul (KR)

(72) Inventors: Woochul JUNG, Seoul (KR); Young Woo CHOI, Yeonsu-gu (KR)

(21) Appl. No.: 14/795,705

(22) Filed: Jul. 9, 2015

(30) Foreign Application Priority Data
Oct. 30, 2014 (KR) 10-2014-0149560

(51) Int. Cl. G06F 17/30

(52) U.S. Cl. CPC G06F 17/30752; G06F 17/30772

(57) ABSTRACT

An automotive music recommendation system may include: a data collector that collects a plurality of musical data from social data kept in a social network; a data analyzer that checks keywords and music metadata by analyzing the musical data; a music manager that creates a matching table by matching the music metadata with the keywords; and a music recommender that checks a keyword according to driving state data by a driver from the matching table and creates a recommendation list using at least one piece of music metadata matched with the keyword. The automotive music recommendation system may recommend music to the driver in accordance with a driving condition on the basis of social data.

### CROSS-REFERENCE TO RELATED APPLICATION

This application claims priority to and the benefit of Korean Patent Application No. 10-2014-0149560 filed in the Korean Intellectual Property Office on Oct. 30, 2014, the entire contents of which are incorporated herein by reference.

### BACKGROUND OF THE INVENTION

(a) Field of the Invention

The present invention relates to an automotive music recommendation system, and more particularly, to an automotive music recommendation system and method that can recommend music in accordance with conditions of a drive on the basis of social data. (b) Description of the Related Art

Recently, as most people possess vehicles with improvement of the level of life, passengers stay in vehicles for increasingly more time due to long-distance driving for a trip or traffic congestion. Accordingly, various facilities for the passengers staying in vehicles for a long time are provided in the vehicles.

A typical one of the facilities is a car audio system such as a radio, a cassette player, and a CD player. Drivers can listen to music or radio broadcasting using the car audio system.

Such a car audio system has an external audio connector for connecting portable audio devices such as a portable cassette player, a CD player, an MP3 player, and a mobile communication device. A portable audio device is connected to a car audio system in a vehicle through an external audio connector or local wireless communication, and music is provided from the portable audio device and output through speakers of the vehicle.

That is, when a driver has kept music that he/she wants in a portable audio device, a vehicle sequentially plays the music through a car audio system. Further, music listed on a music application in a portable audio device can be sequentially played by a car audio system in a vehicle.

In the past, since drivers had to operate a potable audio device in person when they wanted to listen to music while driving, they turned their eyes off the front area, so it may cause a critical result in terms of safe driving. Accordingly, drivers have difficulty in listening to music that is suitable for the current driving condition and that they have preferred in the past.

The Description of the Related Art is made to help understanding the background of the present invention and may include matters outside of the related art known to those skilled in the art.

### DOCUMENTS OF RELATED ART

### Patent Document

(Patent Document 1) Patent Laid-Open Publication No. 10-2014-0053434 (2014 May 8)

(Patent Document 2) Patent No. 10-1143508 (2012Apr. 30)

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an automotive music recommendation system and method having advantages of recommending music for a vehicle that may recommend music to a driver in consideration of weather, a season, a road type, a traffic condition, and time on the basis of several pieces of music collected from blogs, SNS, and web pages.

Further, the present invention has been made in an effort to provide an automotive music recommendation system and method having advantages of being capable of collecting and matching at least a piece of music with a keyword on the basis of social data, extracting at least a piece of music in accordance with the condition of a driver, using the matched keyword, and then providing it to the driver.

An exemplary embodiment of the present invention provides an automotive music recommendation system including: a data collector that collects a plurality of musical data from social data kept in a social network; a data analyzer that checks keywords and music metadata by analyzing the musical data; a music manager that creates a matching table by matching the music metadata with the keywords; and a music recommender that checks a keyword according to driving state data by a driver from the matching table and creates a recommendation list using at least one piece of music metadata matched with the keyword.

The music manager may check whether there is music metadata analyzed by the data analyzer in a matching table kept in advance, may check whether a keyword matched with the music meta data is the same as a keyword analyzed by the data analyzer in the matching table, when there is music metadata in the matching table, and may give a weight value to the music metadata when the keywords are the same.

The data analyzer may extract situational texts or emotional texts by analyzing texts of the musical data and check keywords on the basis of the situational texts or the emotional texts.

The automotive music recommendation system may further include a data detector that detects the driving state data, when receiving a request for recommending music from the driver.

The driving state data may include at least one of weather data, time data, traffic situation data, road type data, season data, driver's emotion data, and vehicle mode data.

The music metadata may include at least one of music identification data, location data, title, genre, singer's name, album data, and lyric data.

Another exemplary embodiment of the present invention provides an automotive music recommendation method including: a) collecting a plurality of musical data from social data kept in a social network; b) checking keywords and music metadata by analyzing the musical data; (c) creating a matching table by matching the music metadata with the keywords; (d) checking keywords according to driving state data by a driver from the matching table; and (e) creating a recommendation list using at least one piece of music metadata matched with the keywords from the matching table.

Another exemplary embodiment of the present invention provides an automotive music recommendation method including: collecting a plurality of musical data from social data kept in a social network; checking keywords and music metadata by analyzing the musical data; creating a matching table by matching the music metadata with the keywords; receiving a request for recommending music from a driver; detecting driving state data when receiving the request for recommending music; checking keywords according to the driving state data from the matching table; creating a recommendation list using at least one piece of music metadata matched with the keywords from the matching table; and playing the recommendation list.

According to an exemplary embodiment of the present invention, it is possible to recommend music to a driver in consideration of weather, a season, a road type, a traffic condition, and time on the basis of several pieces of music collected from blogs, SNS, and web pages, so a driver may enjoy various kinds of music.

Further, since a driver may listen to music according to the driving situations even without specifically operating a portable audio device while driving, it is possible to safely drive.

In addition, effects that may be obtained or expected from exemplary embodiments of the present invention are directly or suggestively described in the following detailed description. That is, various effects expected from exemplary embodiments of the present invention will be described in the following detailed description.

### BRIEF DESCRIPTION OF THE DRAWINGS

FIG. 1 is a schematic diagram illustrating an automotive music recommendation system according to an exemplary embodiment of the present invention.

FIG. 2 is a flowchart illustrating a method of managing music contents according to an exemplary embodiment of the present invention.

FIG. 3 is a flowchart illustrating a method of creating a recommendation list according to an exemplary embodiment of the present invention.

### DETAILED DESCRIPTION OF THE INVENTION

The operation principles of an automotive music recommendation system and method according an exemplary embodiment of the present invention will be described hereafter with reference to the accompanying drawings. However, the drawings to be described below and the following detailed description relate to one preferred exemplary embodiment of various exemplary embodiments for effectively explaining the characteristics of the present invention. Therefore, the present invention should not be construed as being limited to the drawings and the following description.

Further, in the description of the present invention, the detailed description of related well-known configurations and functions is not provided, when it is determined as unnecessarily making the scope of the present invention unclear. Further, the terminologies to be described below are ones defined in consideration of their function in the present invention and may be changed by the intention of a user or an operator or a custom. Therefore, their definition should be determined on the basis of the description of the present invention.

Further, in the following exemplary embodiments, the terminologies are appropriately changed, combined, or divided so that those skilled in the art may clearly understand them, in order to efficiently explain the main technical characteristics of the present invention, but the present invention is not limited thereto.

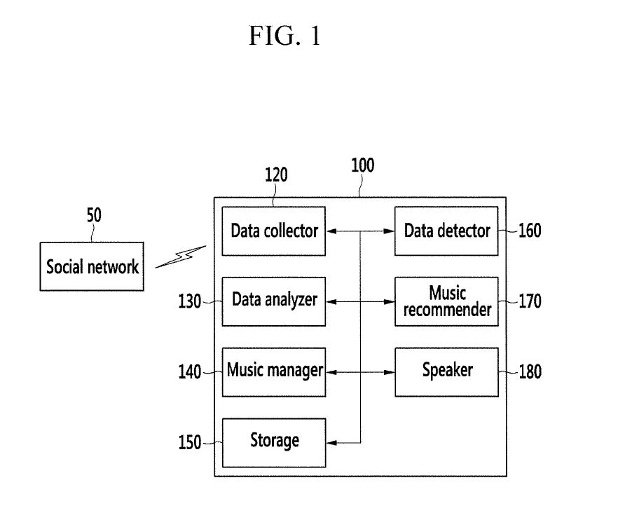

Hereinafter, exemplary embodiments of the present invention will be described in detail with reference to the accompanying drawings. FIG. 1 is a schematic diagram illustrating an automotive music recommendation system according to an exemplary embodiment of the present invention.

An automotive music recommendation system 100 includes a data collector 120, a data analyzer 130, a music manager 140, a storage 150, a data detector 160, a music recommender 170, and a speaker 180.

The data collector 120 collects several pieces of musical data from social data in a social network 50.

The social network may be any one of SNS (Social Network Service) such as Twitter, Facebook, and web sites such as various music sites and blogs.

The social data may be any one of videos, texts, sounds, music contents, photographs, and images.

The musical data may not only be music contents, but musical data such as texts or music videos made by the users of blogs and SNS.

The data analyzer 130 checks keywords on the basis of the musical data collected by the data collector 120.

In other words, the data analyzer 130 extracts situational texts or emotional texts by analyzing the musical data. The situational texts show words or sentences relating to situation while a vehicle is driven, and may be implemented, for example as music to listen to when a driver takes a drive, music to listen to when traffic is jammed, and music to listen to when a driver drives on a highway. The emotional texts show words or sentences relating to the emotion of a driver, and may be implemented, for example, as music to listen to when a driver is depressed, music to listen to when a driver is sick, and music making a driver cry.

The data analyzer 130 checks the keywords on the basis of the situational texts and the emotional texts. That is, the data analyzer 130 checks the situational texts and the emotional texts and finds keywords that may typically express the situational texts and the emotional texts.

Further, the data analyzer 130 checks music metadata on the basis of the musical data. The music metadata may include at least one of music identification data, location data, title, genre, singer's name, album data, and lyric data.

The music identification data may be data allowing for identification of music contents. The location data, which is data about the location where music contents may be played, may be a URL (Uniform Resource Locator). The album data, which is data about the albums with music contents, may include album publication dates, album titles, and album title songs.

The music manager 140 creates a matching table by matching the music metadata with keywords and manages the matching table. In detail, the music manager 140 receives keywords and music metadata analyzed on the basis of the musical data by the data analyzer 130. The music manager 140 determines whether there is music metadata in a matching table previously kept in the storage 150, before matching the music metadata with the keywords. When there is music metadata in the matching table kept in the storage 150, the music manager 140 applies a weight value to the music metadata in the matching table.

When there is no music metadata in the matching table kept in the storage 150, the music manager 140 creates a matching table by matching the music metadata with the keywords. The music manager 140 may control the storage 150 so that the created matching table is kept in the storage 150.

The storage 150 keeps data created by the automotive music recommendation system 100 and data for recommending music. That is, the storage 150 may keep matching tables for each keyword under the control of the music manager 140. The storage 150 may keep musical data collected by the data collector 120.

The data detector 160 detects driving state data. In other words, when a request for recommending music is input by a driver, the data detector 160 detects driving state data for the point of time of the request.

The driving state data is data about the situations around the vehicle that is running. For example, the driving state data may include at least one of weather data, time data, traffic situation data, road type data, season data, driver's emotion data, and vehicle mode data. The weather data shows the weather while a vehicle runs, and may be expressed as ‘rain’, ‘snow’, and ‘clear’. The time data shows time while a vehicle runs, and may be expressed as a going-to-work time and leaving-the-office time or may show the exact time such as 7 a.m. or 2 p.m. The traffic situation data shows the traffic situation around a vehicle that is running, such as ‘congested’, ‘well’, and ‘normal’. The road type data shows the type of a road on which a vehicle is running, such as a highway, a common road, and a state road. The season data shows the season in which a vehicle is running, such as spring, summer, fall, and winter. The driver emotion data may show the driver's emotion such as sadness and happiness. The vehicle mode data shows driving modes of a vehicle such as a sports mode and a normal mode.

The music recommender 170 creates a music list on the basis of the driving condition information of a driver, when it is requested to recommend music by the driver. In detail, when a driver inputs a request for music recommendation, the music recommender 170 checks a keyword according to the driving state data of the driver from a matching table. The music recommender 170 creates a recommendation list using at least one piece of music metadata matched with the keyword from the matching table. Further, the music recommender 170 controls the speaker 180 so that the created recommendation list may be output through the speaker 180.

The speaker 180 outputs music contents. That is, the speaker 180 outputs at least one music content included in the recommendation list created by the music recommender 170.

The components of the automotive music recommendation system 100 according to an exemplary embodiment of the present invention described with reference to FIG. 1 may be integrated or subdivided, so it should be understood that components capable of those functions described above may be the components of the automotive music recommendation system 100 according to an exemplary embodiment of the present invention, irrespective of the names. An automotive music recommendation method according to an exemplary embodiment of the present invention is described hereafter under the assumption that the main body in each step is not the corresponding component, but the automotive music recommendation system 100.

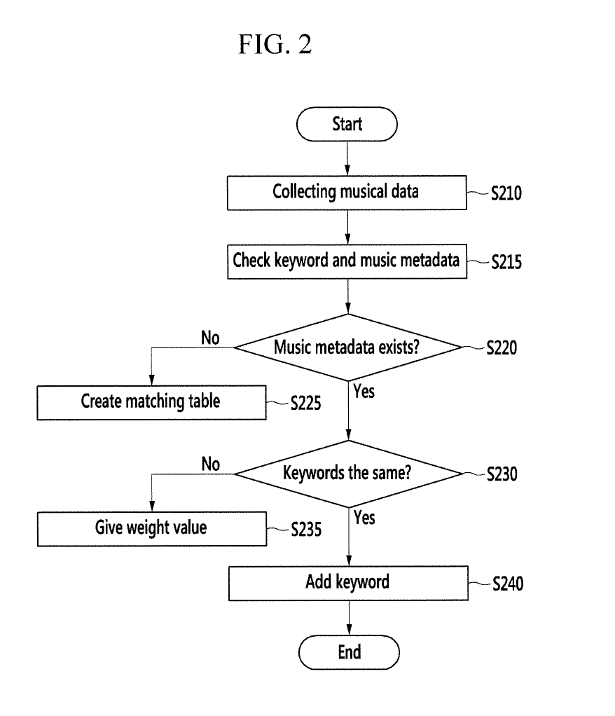

FIG. 2 is a flowchart illustrating a method of managing music contents according to an exemplary embodiment of the present invention.

Referring to FIG. 2, the automotive music recommendation system 100 collects musical data from social data in a social network (S210). The automotive music recommendation system 100 may collect musical data from social data in a social network, using crawling.

The automotive music recommendation system 100 checks the keywords and music metadata of the musical data collected in step S210. In detail, the automotive music recommendation system 100 sets keywords that may represent a plurality of texts having similar meanings in advance. For example, the automotive music recommendation system 100 may set a keyword of ‘sadness’ for texts such as ‘sad’, ‘separation’, and ‘depression’.

Further, the automotive music recommendation system 100 extracts at least one of a situational text and an emotional text by analyzing the texts in the musical data. The automotive music recommendation system 100 also checks keywords on the basis of at least one of the situational text and the emotional text.

For example, when musical data says “not wanted to recommend music about separation”, the automotive music recommendation system 100 may extract “separation” that is an emotional text from the musical data and extract “not wanted” that is music metadata. Further, the automotive music recommendation system 100 may find “sadness” that is a keyword based on “separation” that is an emotional text.

The automotive music recommendation system 100 determines whether there is music metadata found in step S215 in a matching table kept in advance.

When there is no music metadata in the matching table kept in advance, the automotive music recommendation system 100 creates a matching table by matching the music metadata with the keywords (S225).

When there is music metadata in the matching table kept in advance, the automotive music recommendation system 100 determines whether the keyword matched with the music metadata in the matching table kept in advance is the same as the keyword found in step S215 (S230).

When the keyword matched with the music metadata in the matching table is the same as the keyword of the musical data, the automotive music recommendation system 100 gives a weight value to the music metadata (S235).

When the keyword matched with the music metadata in the matching table is not the same as the keyword of the musical data, the automotive music recommendation system 100 adds the keyword found in step S215 to the music metadata (S240).

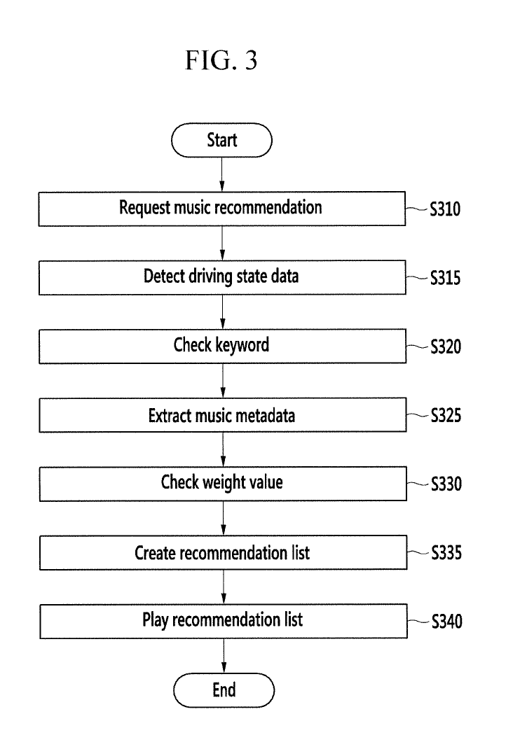

FIG. 3 is a flowchart illustrating a method of creating a recommendation list according to an exemplary embodiment of the present invention.

Referring to FIG. 3, the automotive music recommendation system 100 is requested by a driver to recommend music (S310).

The automotive music recommendation system 100 detects driving state information to recommend music appropriate to the condition or emotion of the driver (S315). That is, the automotive music recommendation system 100 detects driving state information including at least one of weather data, time data, traffic situation data, road type data, season data, driver's emotion data, and vehicle mode data that show the situations around a vehicle, when the automotive music recommendation system 100 receives a request for recommending music from the driver. For example, when wipers are in operation and temperature is under zero, the automotive music recommendation system 100 may detect the weather data as snow. For another example, when the acceleration or the speed of a vehicle is less than a reference speed, the automotive music recommendation system 100 may detect the traffic situation data as congestion.

The automotive music recommendation system 100 checks keywords according to the driving state data from a matching table (S320). That is, the automotive music recommendation system 100 checks the keywords relating to the driving state data from a plurality of keywords kept in the matching table. For example, when road type data that represents a highway is included in the driving state data, the automotive music recommendation system 100 may find a keyword ‘drive’ relating to the driving state data from a plurality of keywords such as ‘drive’, ‘snow’, and ‘sadness’ kept in the matching table.

The automotive music recommendation system 100 extracts at least one piece of music metadata matched with the keyword found from the matching table in step S320 (S325). For example, the automotive music recommendation system 100 extracts at least one piece of music metadata matched with the keyword ‘drive’ from the matching table.

The automotive music recommendation system 100 extracts at least one piece of music metadata and checks a weight value of the music metadata from the matching table (S330).

The automotive music recommendation system 100 creates a recommendation list on the basis of music metadata with a large weight value (S335). That is, the automotive music recommendation system 100 arranges music metadata in order of weight values from greatest to smallest on the basis of the weight values of the music metadata and creates a recommendation list by extracting a set number of music metadata. The set number means the number of pieces of music metadata to be included in the recommendation list, and it may be set by a driver or a manager who manages the automotive music recommendation system 100.

The automotive music recommendation system 100 plays the recommendation list created in step S335. For example, when music contents capable of playing music are included in the recommendation list, the automotive music recommendation system 100 may play the music contents included in the recommendation list. When the location information of the kept music contents is included in the recommendation list, the automotive music recommendation system 100 may play the music contents on the basis of the location information.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An automotive music recommendation system comprising:
a data collector that collects a plurality of musical data from social data kept in a social network;
a data analyzer that checks keywords and music metadata by analyzing the musical data;
a music manager that creates a matching table by matching the music metadata with the keywords; and
a music recommender that checks a keyword according to driving state data by a driver from the matching table and creates a recommendation list using at least one piece of music metadata matched with the keyword.

2. The system of claim 1, wherein the music manager determines whether there is music metadata analyzed by the data analyzer in a matching table kept in advance, determines whether a keyword matched with the music meta data in the matching table is the same as a keyword analyzed by the data analyzer, when there is music metadata in the matching table, and gives a weight value to the music metadata when the keywords are the same.

3. The system of claim 1, wherein the data analyzer extracts situational texts or emotional texts by analyzing texts of the musical data and checks keywords on the basis of the situational texts or the emotional texts.

4. The system of claim 1, further comprising a data detector that detects the driving state data, upon a request for recommending music from the driver.

5. The system of claim 1, wherein the driving state data includes at least one of weather data, time data, traffic situation data, road type data, season data, driver's emotion data, and vehicle mode data.

6. The system of claim 1, wherein the music metadata includes at least one of music identification data, location data, title, genre, singer's name, album data, and lyric data.

7. An automotive music recommendation method comprising:
(a) collecting a plurality of musical data from social data kept in a social network;
(b) checking keywords and music metadata by analyzing the musical data;
(c) creating a matching table by matching the music metadata with the keywords;
(d) checking keywords according to driving state data by a driver from the matching table; and
(e) creating a recommendation list using at least one piece of music metadata matched with the keywords from the matching table.

8. The method of claim 7, wherein the step (c) includes:
determining whether there is the music metadata analyzed in the step (b) in a matching table kept in advance;
when there is music metadata analyzed in the step (b) in the matching table kept in advance, determining whether a keyword matched with the music meta data in the matching table kept in advance is the same as a keyword analyzed in the step (b); and
when the keyword matched with the music meta data in the matching table kept in advance is the same as the keyword analyzed in the step (b), giving a weight value to music metadata in the matching table kept in advance.

9. The method of claim 8, wherein the step (c) further includes: when the music metadata analyzed in the step (b) is not in the matching table kept in advance, creating a matching table by matching the music metadata with the keywords.

10. The method of claim 8, wherein the step (c) further includes: when the keyword matched with the music metadata in the matching table kept in advance is not the same as the keyword analyzed in the step (b), adding a keyword obtained by analyzing the musical data to the music metadata.

11. The method of claim 7, wherein the step (b) includes:
extracting at least one of situational texts and emotional texts by analyzing texts of the musical data; and
checking the keywords on the basis of at least one of the situational texts and the emotional texts.

12. The method of claim 7, wherein the driving state data includes at least one of weather data, time data, traffic situation data, road type data, season data, driver's emotion data, and vehicle mode data.

13. The method of claim 7, wherein the music metadata includes at least one of music identification data, location data, title, genre, singer's name, album data, and lyric data.

14. An automotive music recommendation method comprising:
collecting a plurality of musical data from social data kept in a social network;
checking keywords and music metadata by analyzing the musical data;
creating a matching table by matching the music metadata with the keywords;
receiving a request for recommending music from a driver;
detecting driving state data when receiving the request for recommending music;
checking keywords according to the driving state data from the matching table;
creating a recommendation list using at least one piece of music metadata matched with the keywords from the matching table; and
playing the recommendation list.

15. The method of claim 14, wherein the checking of keywords and music metadata by analyzing the musical data includes:
extracting at least one of situational texts and emotional texts by analyzing texts of the musical data; and
checking the keywords on the basis of at least one of the situational texts and the emotional texts.

16. The method of claim 14, wherein the creating a matching table comprises:
determining whether there is music metadata obtained by analyzing the musical data in a matching table kept in advance;
when there is music metadata obtained by analyzing the musical data is in the matching table kept in advance, determining whether a keyword matched with the music meta data in the matching table is the same as a keyword obtained by analyzing the musical data ; and
when the keyword matched with the music meta data in the matching table kept in advance is the same as the keyword obtained by analyzing the musical data, giving a weight value to music metadata in the matching table kept in advance.

17. The method of claim 16, wherein the creating a recommendation list includes:
extracting at least one piece of music metadata matched with the keywords from the matching table;
checking a weight value of at least one piece of music metadata extracted from the matching table; and
creating a recommendation list including music metadata of a set number of pieces in order of weight values from greatest to smallest.
